(19) United States
(12) Patent Application Publication
(10) Pub. No.: US 2017/0164800 A1
(43) Pub. Date: Jun. 15, 2017

(54) PEDESTAL

(71) Applicant: Kabushiki Kaisha Cosmo Life, Hyogo (JP)

(72) Inventor: Shingo ARAKAWA, Hyogo (JP)

(21) Appl. No.: 15/118,160

(22) PCT Filed: Feb. 28, 2014
(86) PCT No.: PCT/JP2014/055059

§ 371 Date: Aug. 11, 2016

(30) Foreign Application Priority Data
Feb. 12, 2014 (JP) 2014-024279

(51) Int. Cl. A47L 9/28; B67D 3/00

(52) U.S. Cl. CPC A47L 9/2873; B67D 3/0022; B67D 3/0009; B67D 3/0032; B67D 3/0038; B67D 3/0077; B67D 3/0074; A47L 9/2894; A47L 9/2889; A47L 2201/022

(57) ABSTRACT

A pedestal includes a seating surface portion on which water dispenser is to be placed; legs defining, under the seating surface portion, a robot receiving space which a self-propelled cleaning robot for cleaning a floor surface can enter and exist, and in which the cleaning robot can be received; and a charging station provided in the robot receiving space for charging the self-propelled cleaning robot. The pedestal allows the owner of an existing water dispenser to easily find a place for both this water dispenser and a self-propelled cleaning robot.

### TECHNICAL FIELD

This invention relates to a pedestal for use with a water dispenser.

### BACKGROUND ART

While older water dispensers were mainly used in offices and hospitals, with growing interest in safety of water and health, water dispensers are now increasingly used in households too. Water dispensers typically include a temperature adjusting tank in which drinking water is stored, a cooling device for cooling drinking water in the temperature adjusting tank, and a cold water cock for dispensing drinking water in the temperature adjusting tank to outside, whereby tasty drinking water can be used at any time simply by operating the cold water cock (see e.g., the below-identified Patent document 1).

On the other hand, self-propelled cleaning robots are gathering much attention as home appliances which save much time and trouble for cleaning. A typical self-propelled cleaning robot includes a travel unit which enables the robot to travel on a floor surface, a dust collecting unit for removing dust and garbage on the floor surface, and a built-in rechargeable battery for supplying electricity to the travel unit and the dust collecting unit to drive them. Since such a self-propelled cleaning robot autonomously cleans a floor surface without being controlled by a human, it is capable of cleaning a floor surface even while there is no one in the house or in the room, and thus is extremely useful (see, e.g., the below-identified Patent document 2).

### PRIOR ART DOCUMENTS

### Patent Documents

Patent document 1: JP Patent Publication 2011-046446A
Patent document 2: JP Patent Publication 2009-238055A

### SUMMARY OF THE INVENTION

### Object of the Invention

Once cleaning is complete, a self-propelled cleaning robot returns, while being self-propelled, to a charging station placed on a floor surface for charging. In other words, while not in use, a self-propelled cleaning robot is not stored in a closet like an ordinary cleaner, but left on a floor surface where there is the charging station. It is therefore necessary to find a place on the floor for charging the cleaning robot, but the cleaning robot left on the floor of a limited living space can be a major obstacle.

Possessing both a self-propelled cleaning robot and a water dispenser would extremely improve the convenience of life, but this will make it necessary to find both a place for charging the self-propelled cleaning robot and a place for installing the water dispenser, and overcrowd the living space.

The inventor of the present application discovered that there is a vertically elongated dead space over a self-propelled cleaning robot while the cleaning robot is being charged, and that it would be possible to extremely effectively use the limited living space if a water dispenser is installed in this dead space.

However, it is difficult to install an existing water dispenser in the above-described dead space.

An object of the present invention is to make it possible for the owner of an existing water dispenser to easily find a place for this water dispenser and a self-propelled cleaning robot.

### Means for Achieving the Object

In order to achieve this object, this invention provides a pedestal comprising a seating surface portion configured such that a water dispenser which is capable of dispensing drinking water in a temperature adjusting tank to outside through a cock is placed on the seating surface portion, legs defining, under the seating surface portion, a robot receiving space which a self-propelled cleaning robot for cleaning a floor space can enter and exit, and in which the self-propelled cleaning robot can be received, and a charging station provided in the robot receiving space and configured to charge the self-propelled cleaning robot.

According to the present invention, since the pedestal defines, between the seating surface portion and the floor surface, a robot receiving space in which the self-propelled cleaning robot can be received, the owner of an existing water dispenser can find a place for both this water dispenser and a self-propelled cleaning robot, simply by deciding the place for the pedestal and placing the water dispenser on the seating surface portion of the pedestal.

Preferably, the pedestal further comprises a groove portion around the seating surface portion so as to be recessed from, and located lower than, the seating surface portion, wherein the groove portion is inclined such that water entering the groove portion collects to a front side where there is an opening through which the self-propelled cleaning robot can enter and exit the robot receiving space, and which is opposite from a rear side where there is the charging station, the rear side being opposite from the opening.

With this arrangement, if water should leak from the water dispenser, the seating surface portion and the groove portion around the seating surface portion receive water, thus preventing leakage of water onto the self-propelled cleaning robot while the cleaning robot is in the robot receiving space. Further, since the groove portion around the seating surface portion serves to collect water to the front side of the pedestal, if water should overflow from the groove portion, water necessarily overflows from the front side of the pedestal, so that water overflowing the groove portion will never reach the charging station, which is located in the rear of the pedestal.

Preferably, the pedestal further comprises a water leakage indicator at the front side and configured to be changed from a non-water-leakage-alarm state to a water leakage alarm state by water entering the groove portion.

With this arrangement, since the groove portion collects water toward the water leakage indicator, thus changing the water leakage indicator to the water leakage alarm state at an early stage, and since the water leakage indicator is located at the front side and thus easily visually recognizable, it is possible to detect water leakage at an early stage.

Preferably, the legs include right and left support legs located at the front side, and defining a width of the opening (5a), and the water leakage indicator is provided utilizing the interior of one of the support legs.

With this arrangement, it is possible to ensure that the opening provided at the front side of the robot receiving space and through which the self-propelled cleaning robot can enter the robot receiving space has a large width, while providing the water leakage indicator at the front side of the pedestal, where the water leakage indicator is more easily visually recognizable.

Preferably, the water leakage indicator comprises a water storage recess formed in the interior of the one of the support legs, and a float inserted in the water storage recess.

With this arrangement, since the interior space of the support leg, which is of a sufficient length to define the robot receiving space, is used to form the water storage recesses, in which are received the float, it is possible to increase the depth and thus the volume of the water storage recesses, and to increase the length of the float, thus increasing the distance by which the float rises due to the buoyancy of water. This increases the length of the portion of the float protruding from the water storage recess when the float has risen due to the buoyancy of water, thus making it possible to reliably notify users of water leakage.

Preferably, the legs comprise front right and front left support legs located at a front side where there is an opening through which the self-propelled cleaning robot can enter and exit the robot receiving space, and which is opposite from a rear side where there is the charging station, the rear side being opposite from the opening, the right and left support legs defining a width of the opening; and a support leg located at the rear side, wherein the charging station includes a transmitter configured to transmit, into the air, guiding electromagnetic waves for guiding the self-propelled cleaning robot to a charging position, and wherein a space between the front right and front left support legs and the transmitter is open from the robot receiving space to an outer space.

With this arrangement, since there is nothing in the space between the right and left support legs and the transmitter to the outer space, the guiding electromagnetic waves transmitted from the transmitter are less likely to be reflected irregularly. This in turn makes it easier for the self-propelled cleaning robot to recognize the guiding electromagnetic waves, so that the cleaning robot can be more easily guided into the robot receiving space.

Preferably, the charging station includes a power tap which can be connected to a power cord of the water dispenser.

With this arrangement, both electric power for the water dispenser and electric power for charging at the charging station can be supplied from a single power outlet. This makes it possible to install the water dispenser and the pedestal even at a location where there is only a small number of power outlets.

### Advantages of the Invention

According to the present invention, the owner of an existing water dispenser can find a place for both this water dispenser and a self-propelled cleaning robot, simply by deciding the place for the pedestal according to the present invention and placing the water dispenser on the seating surface portion of the pedestal. This makes it possible for the owner of an existing water dispenser to easily find a place for this water dispenser and a self-propelled cleaning robot.

### BRIEF DESCRIPTION OF THE DRAWINGS

FIG. 1 is a front view of a water dispenser embodying the present invention.

FIG. 2 is a sectional view taken along line II-II of FIG. 1.

FIG. 3 is an enlarged sectional view of and around a dispenser tray of FIG. 2.

FIG. 4 is a sectional view taken along line IV-IV of FIG. 3.

FIG. 5 is a sectional view taken along line V-V of FIG. 3.

FIG. 6 is a sectional view taken also along line V-V of FIG. 3, and showing the relationship between a self-propelled cleaning robot, right and left support legs, and a charging station, of the embodiment.

FIG. 7 is an enlarged sectional view taken along line VI-VI of FIG. 4.

FIG. 8 is an enlarged sectional view of a float receiving recess shown in FIG. 7, in which water is in the float receiving recess.

FIG. 9 is an enlarged sectional view showing a modification of a water leakage indicator shown in FIG. 7.

FIG. 10 is an enlarged sectional view of a float receiving recess shown in FIG. 9, in which water is in the float receiving recess.

### BEST MODE FOR EMBODYING THE INVENTION

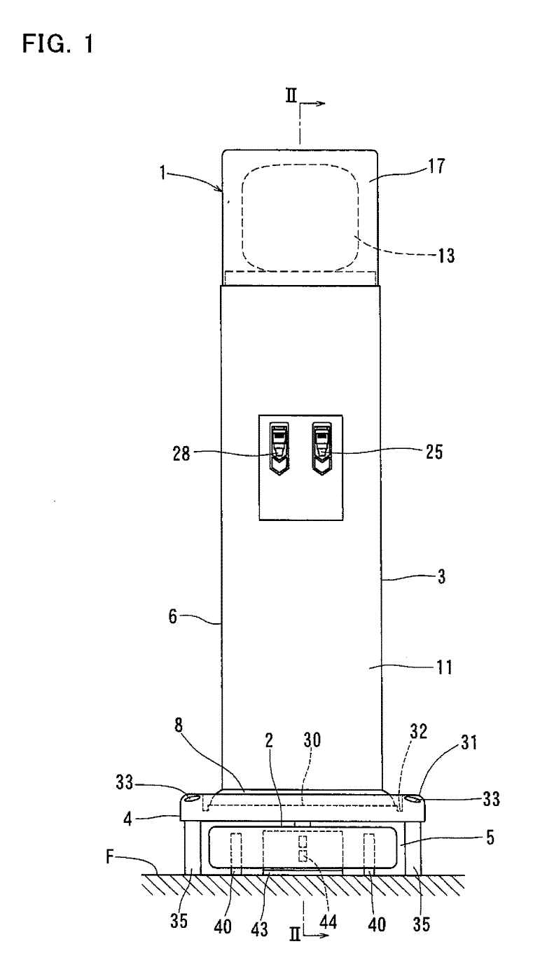

FIG. 1 shows, as an example, a water dispenser 1, a self-propelled cleaning robot 2 for cleaning a floor surface F while autonomously traveling on the floor surface F, and a pedestal 4 supporting the bottom of the housing 3 of the water dispenser 1, the pedestal 4 embodying the present invention.

The pedestal 4 is disposed between the bottom end of the housing 3 and the floor surface F to vertically separate the housing 3 from the floor surface F, thereby defining, between the housing 3 and the floor surface F, a robot receiving space 5 that the self-propelled cleaning robot 2 can enter and exit while being self-propelled.

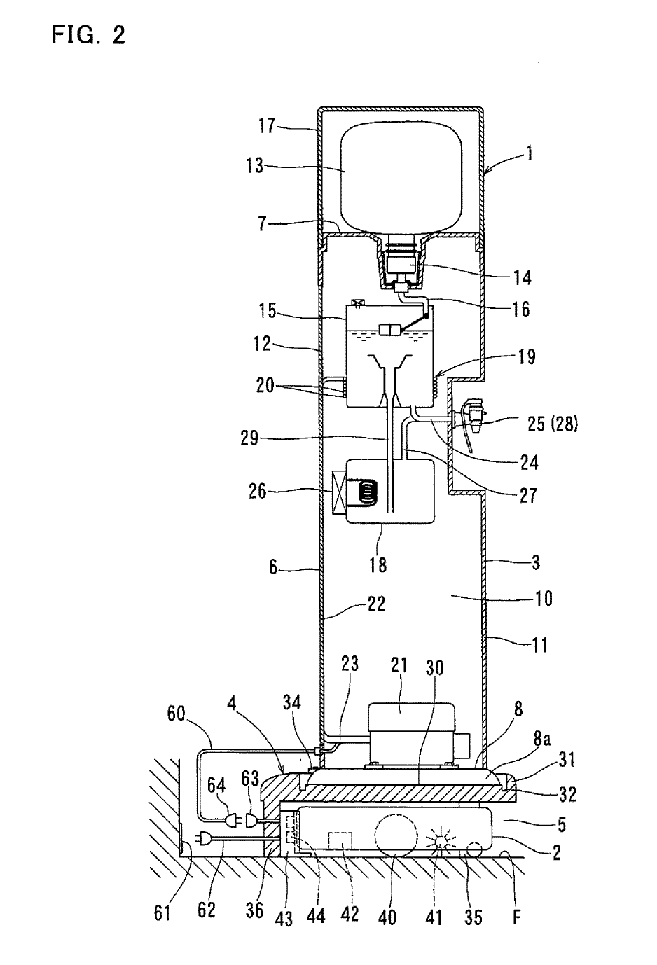

As shown in FIG. 2, the housing 3 comprises a tubular wall 6, a top panel 7, and a bottom panel 8. The tubular wall 6 extends in the vertical direction. The top panel 7 is mounted to the upper portion of the tubular wall 6. The bottom panel 8 is mounted to the lower portion of the tubular wall 6. The bottom panel 8 is fixed to the tubular wall 6 by screws, not shown. The tubular wall 6 comprises a pair of right and left side panels 10, a front panel 11, and a rear panel 12. The front panel 11 couples together the front edges of the side panels 10. The rear panels 12 couples together the rear edges of the side panels 10. In the embodiment, the tubular wall 6 is a cylindrical member having a substantially circular outer periphery, but it may be a rectangular tube member having substantially a rectangular outer periphery.

A replaceable raw water container 13 is detachably set on the top panel 7 of the housing 3, with its water outlet 14 facing down. The raw water container 13 can hold up to about 8 to 20 liters of water. The top panel 7 is provided with a water introducing pipe 16 through which, with the raw water container 13 placed on the top panel 7, drinking water is introduced from the raw water container 13 into a first temperature adjusting tank 15 in the housing 3. A cosmetic cover 17 is mounted to the upper portion of the housing 3 to cover the raw water container 13.

Besides the first temperature adjusting tank 15, a second temperature adjusting tank 18 is mounted in the housing 3. Low-temperature drinking water is stored in the first temperature adjusting tank 15, while high-temperature water is stored in the second temperature adjusting tank 18. A cooling device 19 is mounted to the first temperature adjusting tank 15, and cools the drinking water in the first temperature adjusting tank 15. The cooling device 19 comprises a refrigerant pipe 20, a compressor 21 and a condenser 22 which are connected together by pipes. The refrigerant pipe 20 is wound around the outer periphery of the temperature adjusting tank 15. The compressor 21 is fixed to the bottom panel 8 of the housing 3, while the condenser 22 is fixed to the rear panel 12 of the housing 3. When activated, the compressor 21 cools the refrigerant pipe 20 to about −15° C. to −30° C., thereby cooling drinking water in the temperature adjusting tank 15 to low temperature (about 5° C.).

A cold water dispensing pipe 24 is connected to the bottom surface of the temperature adjusting tank 15 so that low-temperature drinking water in the temperature adjusting tank 15 is dispensed to the outside of the housing 3 through the cold water dispensing pipe 24. The cold water dispensing pipe 24 is provided with a cold water cock 25 operable from outside the housing 3 so that by opening the cold water cock 25, low-temperature drinking water in the temperature adjusting tank 15 can be dispensed into e.g., a cup. The cold water cock 25 is provided at the front side of the housing 3 (in other words, the side of the housing 3 where there is the cold water cock 25 is the front side of the housing 13, and its side opposite from the front side is the rear side of the housing 13). The capacity of the temperature adjusting tank 15 to hold drinking water is smaller than that of the raw water container 13, and about 2-4 liters.

The second temperature adjusting tank 18 is located under the first temperature adjusting tank 15. A heating device 26 is mounted to the second temperature adjusting tank 18 to heat drinking water in the temperature adjusting tank 18. In FIG. 2, the heating device 26 is a sheath heater, but it may be a band heater. The sheath heater includes a heating wire received in a metal pipe and configured to heat up when energized, and is mounted to the temperature adjusting tank 18 to extend through the wall of the temperature adjusting tank 18 and in the temperature adjusting tank 18. The band heater is a cylindrical heating element in which is embedded a heating wire configured to heat up when energized, and would be mounted to the temperature adjusting tank 18 in close contact with the outer periphery of the temperature adjusting tank 18. The heating device 26 keeps the drinking water in the temperature adjusting tank 18 at high temperature (about 90° C.).

A hot water dispensing line 27 is connected to the top surface of the temperature adjusting tank 18 so that high-temperature drinking water in the temperature adjusting tank 18 is dispensed to the outside of the housing 3 through the hot water dispensing line 27. The hot water dispensing line 27 is provided with a hot water cock 28 operable from outside the housing 3 so that by opening the hot water cock 28, high-temperature drinking water in the temperature adjusting tank 18 can be dispensed e.g., into a cup. As with the cold water cock 25, the hot water cock 28 is provided at the front side of the housing 3. The capacity of the temperature adjusting tank 18 is about 1-2 liters.

The first temperature adjusting tank 15 and the second temperature adjusting tank 18 communicate with each other through a connecting pipe 29 such that when drinking water is discharged from the temperature adjusting tank 18, the same amount of drinking water as the amount of drinking water discharged from the temperature adjusting tank 18 flows from the temperature adjusting tank 15 into the temperature adjusting tank 18 through the tank connecting pipe 29, thereby always filling the temperature adjusting tank 18 with drinking water.

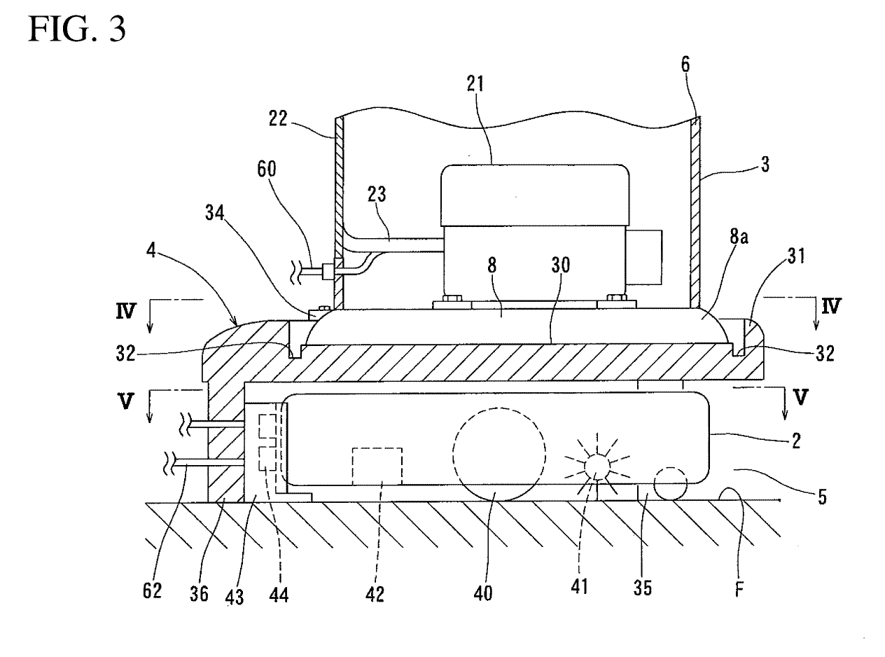

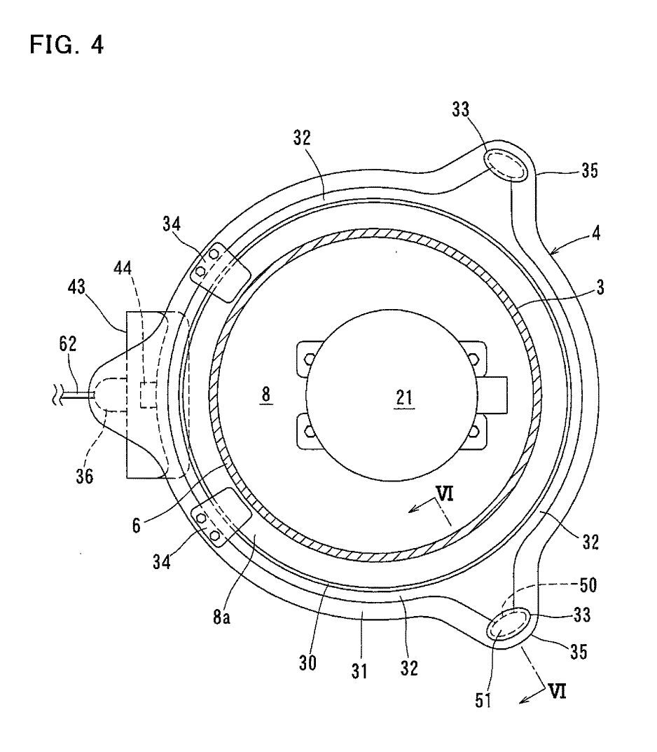

As shown in FIGS. 3 and 4, the pedestal 4 includes a seating surface portion 30 on which is placed the housing 3 of the water dispenser 1, a peripheral wall 31 surrounding, as viewed from top, the seating surface portion 30, a groove portion 32 extending around the seating surface portion 30 so as to be recessed from, and located lower than, the seating surface portion 30, and two water leakage indicators 33 provided in regions surrounded by the peripheral wall 31. The water leakage indicators 33 are configured to change from a non-water-leakage-alarm state to a water leakage alarm state if water collects in the regions surrounded by the peripheral wall 31.

The seating surface portion 30 is a surface having an area equal to or larger than the area of the bottom panel 8 of the housing 3 of the water dispenser 1 so that the housing 3 can be stably supported on the seating surface portion 30 when the former is placed on the latter. In the example shown, the seating surface portion 30 is a horizontal flat surface so that different kinds of housings 3 having bottom panels 8 different in shape from each other can be used.

The peripheral wall 31 has a protruding portion protruding vertically upwardly further than the seating surface portion 30 and completely surrounding the seating surface portion 30 without interruption. Thus, if water leaks from the housing 3 with the housing 3 placed on the seating surface portion 30, the protruding portion is capable of keeping such leaked water inside the peripheral wall 31 until the water level reaches the top edge of the protruding portion.

As shown in FIG. 4, the groove portion 32 is, as viewed from top, an annular groove extending between the seating surface portion 30 and the peripheral wall 31, along the peripheral wall 31, so as to surround the seating surface portion 30. The two water leakage indicators 33 are provided at the front side of the seating surface portion 30 (i.e., at the front side of the housing 3) and spaced apart from each other in the right-and-left direction. The groove portion 32 communicates with the water leakage indicators 33.

The pedestal 4 and the housing 3 are fastened together by a fastening means 34 so as not to be movable relative to each other. In this embodiment, the bottom panel 8 of the housing 3 includes a protruding portion 8a protruding outwardly further than the tubular wall 6 of the housing 3. The fastening means 34 comprises presser plates mounted to the peripheral wall 31 of the pedestal 4 so as to be located over, and opposed to, the seating surface portion 30, with the protruding portion 8a of the bottom panel 8 disposed therebetween. The presser plates press down the protruding portion 8a of the bottom panel 8, thereby preventing the movement of the housing 3 relative to the pedestal 4.

As shown in FIGS. 3, 5 and 6, the pedestal 4 includes a plurality of support legs supporting the seating surface portion 30 on the floor surface F, and defining a robot receiving space 5 under the seating surface portion 30. The self-propelled cleaning robot 2, which is capable of cleaning the floor surface F, can enter and exist, and can be received in, the robot receiving space 5.

In this embodiment, the support legs are constituted by a pair of right and left support legs 35 provided at the front side of the housing 3, and a support leg 36 provided at the rear side of the housing 3. The pair of right and left support legs 35 define therebetween an opening 5a through which the self-propelled cleaning robot 2 can enter and exit the robot receiving space 5. The support legs 35 and 36 extend downwardly from positions outside the seating surface portion 30 and are in contact with the floor surface F. The support legs 35 and 36 are taller than the self-propelled cleaning robot 2 to define the robot receiving space 5. The distance between the pair of right and left support legs 35 determines the width W1 of the opening 5a. Width W1 is set to be larger than the width W2 of the self-propelled cleaning robot 2. The self-propelled cleaning robot 2 can enter and exit the robot receiving space 5 from and to the front side of the pedestal 4 through the gap between the pair of right and left support legs 35, while being self-propelled. In the figures, the support legs 35 and 36 are angularly spaced apart from each other by 120 degrees around a vertical axis.

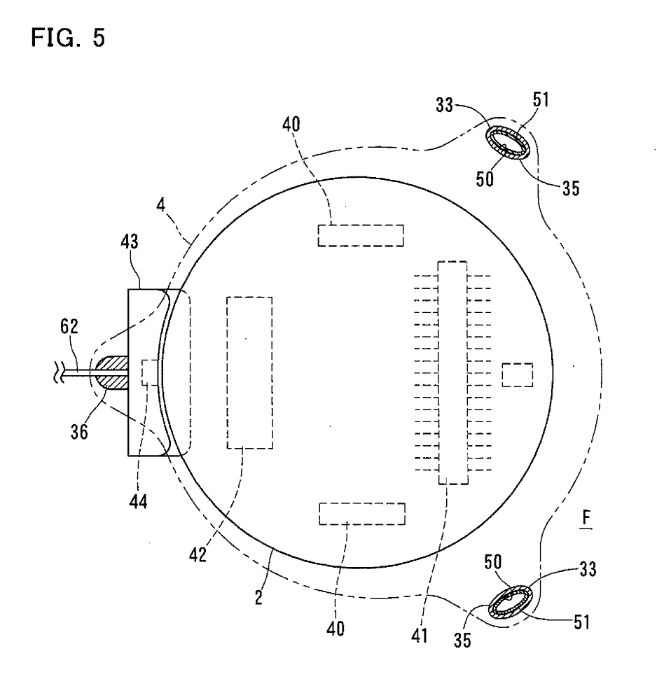

The self-propelled cleaning robot 2 includes a travel unit 40 which allows the robot 2 to travel on the floor surface F, a dust collecting unit 41 for removing dust and trash from the floor surface F, and a built-in rechargeable battery 42 which supplies electric power for driving the travel unit 40 and the dust collecting unit 41. In this embodiment, as shown in FIG. 5, the self-propelled cleaning robot 2 is, as viewed from top, circular in shape, and has a diameter of 25 to 35 cm. Also, the self-propelled cleaning robot 2 has a height of 5 to 10 cm from the floor surface F to its top surface while the robot 2 is traveling on the floor surface F.

The robot receiving space 5 is provided with a charging station 43 capable of charging the rechargeable battery 42 when the self-propelled cleaning robot 2 is received in the robot receiving space 5. The charging station 43 includes charging terminals 44 positioned such that the terminals 44 contact the self-propelled cleaning robot 2 when the self-propelled cleaning robot 2 enters the robot receiving space 5 while being self-propelled. The charging station 43 is fastened to the support leg 36, which is located at the rear side of the housing 3 of the water dispenser 1, by fastening means (not shown) such as bolts such that they will not move relative to each other. In this embodiment, the portion of the pedestal 4 where there is the opening 5a is the front side of the pedestal 4, and the portion of the pedestal 4 opposite from the opening 5a, i.e., its portion where there is the charging station 43 is the rear side of the pedestal 4, and the pedestal is used such that the fore-and-aft direction of the pedestal 4 coincides with the fore-and-aft direction of the housing 3.

The vertical width of the robot receiving space 5 is set to be larger by about 0.5 to 5.0 cm than the height of the self-propelled cleaning robot 2. By setting the former value larger by more than 0.5 cm than the latter value, it is possible to reliably prevent the self-propelled cleaning robot 2 from interfering with the pedestal 4. By setting the former value larger by less than 5.0 cm than the latter value, the lengths of the support legs 35 and 36 of the pedestal 4 can be made sufficiently short to stabilize the position of the housing 3 of the water dispenser 1.

In order to minimize the area of the floor surface F occupied by the pedestal 4 when placed on the floor surface F, the pedestal 4 is sized so as to be entirely received within an imaginary 50-cm square (preferably within a 45-cm square), as viewed from top.

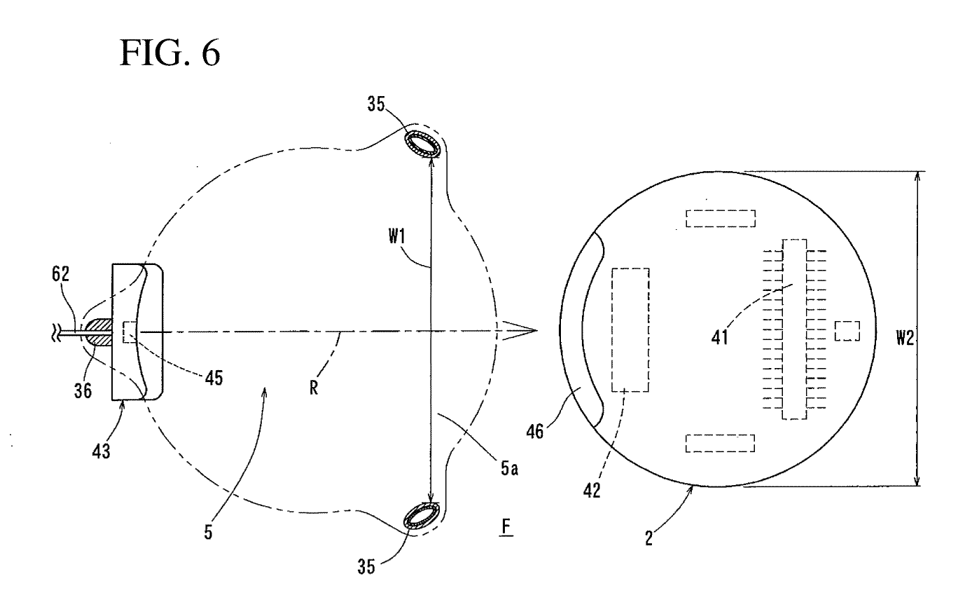

As shown in FIG. 6, the charging station 43 includes a transmitter 45 configured to transmit guiding electromagnetic waves R capable of guiding the self-propelled cleaning robot 2 to the charging position, into the air. The transmitter 45 is provided at a position opposed to the upper central portion of the width W1 of the opening 5a in the fore-and-aft direction. The self-propelled cleaning robot 2 includes a sensor portion 46 capable of receiving the guiding electromagnetic waves R. During autonomous control for charging itself, the self-propelled cleaning robot 2 is configured to enter the robot receiving space 5 through the opening 5a, while autonomously traveling within a rage in which the sensor portion 46 can receive the guiding electromagnetic waves R.

The space between the right and left support legs 35 and the transmitter 45 is open from the robot receiving space 5 to the outer space. The outer space refers to the space which is of the same height as the support legs 35 and 36, and not located under the pedestal 4. Since there is nothing in the space between the right and left support legs 35 and the transmitter 45 to the outer space, the guiding electromagnetic waves R transmitted from the transmitter 45 are less likely to be reflected irregularly.

The groove portion 32, shown in FIG. 4, has a groove bottom inclined such that water flowing into the groove portion 32 collects to the front side. In particular, the groove bottom of the groove portion 32 gradually decreases in height from the rear central portion of the seating surface portion 30 toward the front side along the seating surface portion 30 such that the entire rear portion of the groove bottom is higher than the entire front portion of the groove bottom.

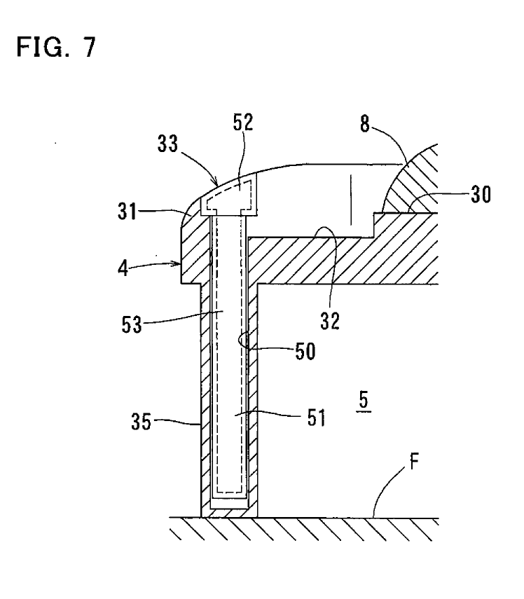

As shown in FIGS. 4 and 7, the water leakage indicators 33 are provided utilizing the interiors of the support legs 35. Specifically, the water leakage indicators 33 each comprise a water storage recess 50 and a float 51. The water storage recess 50 is located at a lower level than, and communicates with, the front side of the groove portion 32, and opens to the top surface of the pedestal 4. The water storage recess 50 has a closed structure such that water flowing into the water storage recess 50 from the groove portion 32 does not leak onto the floor surface F. The float 51 is inserted in the water storage recess 50.

The water storage recesses 50 of the respective water leakage indicators 33 are formed in the support legs 35, which are located at the front side of the pedestal. With this arrangement, the water storage recesses 50 have sufficient volumes because they are formed in the support legs 35; the water leakage indicators 33 can be easily visually recognized because they are located at the front side of the pedestal 4; and the width W1 of the opening 5a, which is located at the front side, is sufficiently large.

In particular, the groove bottom of the groove portion 32 decreases in height from the rear central position of the seating surface portion 30 toward the respective right and left water leakage indicators 33. Also, the groove bottom of the groove portion 32 decreases in height from the front central position of the seating surface portion 30 toward the respective right and left water leakage indicators 33. Since groove portion 32 serves to collect water toward the water leakage indicators 33, the water leakage indicators 33 can change to the water leakage alarm state at an earlier stage.

The float 51 of each water leakage indicator 33 includes a head 52, and a trunk portion 53 extending downwardly from the head 52. While there is no water in the water storage recess 50, the head 52 of the float 51 is exposed to outside, while the trunk portion 53 of the float 51 is hidden in the water storage recess 50 and not seen from outside.

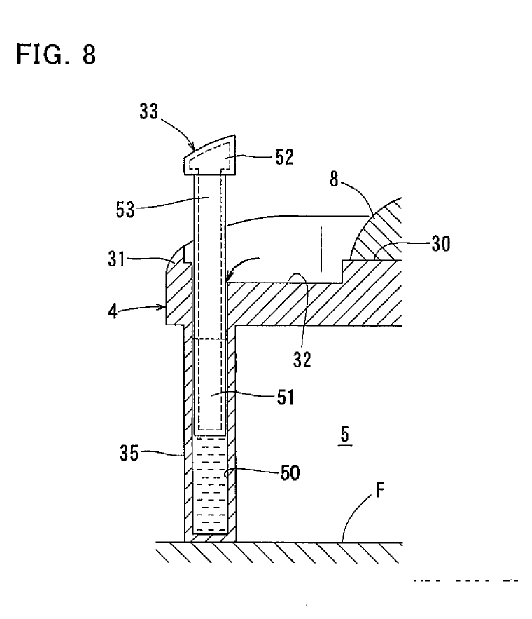

As a whole, the float 51 has a specific gravity smaller than water so that, as shown in FIG. 8, when water flows into the water storage recess 50, the float 51 rises due to the buoyancy of water. In the figures, the float 51 is a hollow member having its surface covered with non-foamed resin, but may be, for example, entirely formed of foamed resin instead. The water leakage indicators 33 of this embodiment are each changeable between the water leakage alarm state and the non-water-leakage-alarm state, depending on whether or not there is water in the water storage recess 50. Specifically, while there is no water in the water storage recess 50 of each water leakage indicator 33, and thus the float 51 is inserted into the water storage recess 50, the water leakage indicator 33 is in the non-water-leakage alarm state; and when the float 51 is afloat on water accumulated in the water storage recess 50, the water leakage indicator 33 is in the water leakage alarm state.

The head 52 has the same color as the surface of the peripheral wall 31. The trunk portion 53 of the float 51 (i.e., the portion that protrudes from the water storage recess 50 and is exposed to outside when the float 51 rises) has a water leakage alarm color or colors which can notify users of the leakage of water. The water leakage alarm color or colors should be different from the color of the peripheral wall 31. For example, if the color of the peripheral wall 31 is black, gray, white, light blue, or brown, the water leakage alarm color or colors may be red, yellow, or alternating red and yellow.

While there is no water in the water storage recess 50, since the float 51 is at the lowest position as shown in FIG. 7, the water leakage alarm color or colors of the trunk portion 53 cannot be seen from outside, that is, the water leakage indicator 33 is in the non-water-leakage-alarm state. When water flows into the water storage recess 50, as shown in FIG. 8, the water detecting float 51 rises due to the buoyancy of water, so that the water leakage alarm color or colors of the trunk portion 53 becomes visible from outside, that is, the water leakage indicator 33 changes to the water leakage alarm state.

As shown in FIG. 2, the housing 3 of the water dispenser 1 carries a power cord 60 through which electric power is supplied to the cooling device 19, the heating device 26, and a control circuit, not shown, for controlling the cooling device 19 and the heating device 26. The charging station 43 is provided with a power cord 62 connected to a power outlet 61. The charging station 43 further includes a power tap 63 which bifurcates from the power cord 62 to supply power. A plug 64 provided at the distal end of the power cord 60 is connected to the power tap 63.

The pedestal 4 is configured such that simply by placing the pedestal 4 in position, and placing the water dispenser 1 on the seating surface portion 30 of the pedestal 4, the pedestal 4 defines the robot receiving space 5, in which the self-propelled cleaning robot 2 can be received, between the seating surface portion 30 and the floor surface F, thereby ensuring a place where both the water dispenser 1 and the self-propelled cleaning robot 2 can be placed. Thus, a user who already owns a water dispenser 1 can easily ensure a place where the water dispenser 1 and the self-propelled cleaning robot 2 can be placed.

The pedestal 4 is configured such that if water should leak from the housing 3 of the water dispenser 1, the seating surface portion 30, which separates the housing 3 from the floor surface F, as well as the groove portion 32, provided around the seating surface portion 30, receives water so as to prevent leakage of water onto the floor surface F, or onto the self-propelled cleaning robot 2, if the robot is received in the robot receiving space 5.

With this pedestal 4, since the groove portion 32 around the seating surface portion 30 is inclined such that water flowing into the groove portion 32 collects to the front side, if water should overflow from the groove portion 32, water necessarily overflows from the front side of the pedestal 4, so that water overflowing the groove portion 32 will never reach the charging station 43, which is located in the rear of the pedestal 4.

Also with this pedestal 4, since water flowing into the groove portion 32 collects to the front side, thereby changing the water leakage indicators 33 to the water leakage alarm state, it is possible to detect water leakage at an earlier stage. Especially if water leaks from the housing 3 at a slow rate (such as if a trace amount of water oozes out), leaked water is less likely to be visually recognized, so that it tends to take a long time until water leakage is detected, which in turn tends to cause e.g., corrosion of the floor surface F. Even in such a situation, however, the water leakage indicators 33 are capable of detecting water leakage at an early stage, thus e.g., preventing corrosion of the floor surface F.

With this pedestal 4, since the water leakage indicators 33 are provided using the interiors of the front support legs 35, which define the opening 5a, it is possible to ensure that the opening 5a, which is provided at the front side of the robot receiving space 5 and through which the self-propelled cleaning robot 2 can enter the robot receiving space 5, has a large width W1, while providing the water leakage indicators 33 at the front side of the pedestal 4, where the water leakage indicators 33 are more easily visually recognizable.

Furthermore, with this pedestal 4, since the interior spaces of the support legs 35, which are of sufficient lengths to define the robot receiving space 5, are used to form the water storage recesses 50, in which are received the floats 51, it is possible to increase the depths and thus the volumes of the water storage recesses 50, and to increase the lengths of the floats 51, thus increasing the distances by which the floats 51 rise due to the buoyancy of water. This increases the lengths of the portions of the floats 51 protruding from the water storage recesses 50 when the floats 51 have risen due to the buoyancy of water, thus making it possible to reliably notify users of water leakage. Also, compared to electric water leakage indicators, the water leakage indicators 33 are simple in structure and thus are less likely to fail, and operate reliably.

With this pedestal 4, since the space between the front right and front left support legs 35 and the transmitter 45 of the charging station 43, which is located at the rear side, is open from the robot receiving space 5 to the outer space, the guiding electromagnetic waves R transmitted from the transmitter 45 are less likely to be reflected irregularly between the support legs 35 and the transmitter 45, so that the self-propelled cleaning robot 2 can be easily guided into the robot receiving space 5.

With this pedestal 4, since the charging station 43 has the power tap 63, to which the power cord 60 of the water dispenser 1 can be connected, both electric power for the water dispenser 1 and electric power for charging at the charging station 43 can be supplied from a single power outlet such as the outlet 61. This makes it possible to install the water dispenser 1 and the pedestal 4 even at a location where there is only a small number of power outlets.

With this water dispenser 1, since the pedestal 4 and the housing 3 are fastened to each other by the fastening means 34 so as not to be movable relative to each other, it is possible to effectively prevent the fall of the housing 3 of the water dispenser 1 even if the housing 3 of the water dispenser 1 is hit by a person or during an earthquake. The water dispenser 1 is thus safe to use.

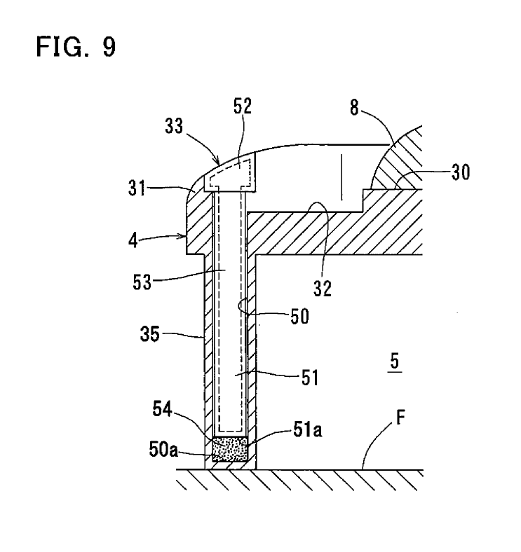

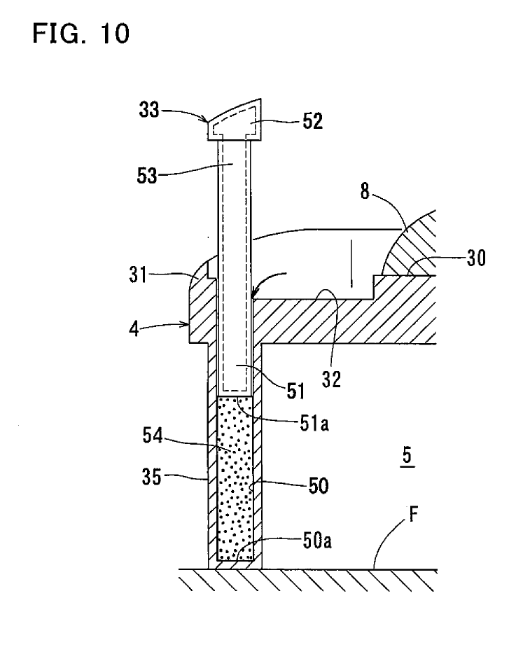

FIGS. 9 and 10 show a different water leakage indicator 33. Elements shown in these figures that correspond to those of the above embodiment are denoted by identical numerals, and their description is omitted.

A water absorbent polymer member 54 is received in the water storage recess 50 of this water leakage indicator 33. The float 51 has a bottom end surface 51a opposed to the inner bottom surface 50a of the water storage recess 50. The water absorbent polymer member 54 is disposed between the bottom end surface 51a of the float 51 and the inner bottom surface 50a of the water storage recess 50. The water absorbent polymer member 54 is made of a water absorbent polymer capable of expanding to 100 times or more of its own weight by absorbing water. Such water absorbent polymers include sodium polyacrylate.

As with the above embodiment, this water leakage indicator 33 also changes between the water leakage alarm state and the non-water-leakage-alarm state. Specifically, while there is no water in the water storage recess 50, since the float 51 is at the lowest position as shown in FIG. 9, the water leakage alarm color or colors of the trunk portion 53 cannot be seen from outside, that is, the water leakage indicator 33 is in the non-water-leakage-alarm state. When water flows into the water storage recess 50, as shown in FIG. 10, the water absorbent polymer member 54 expands by absorbing water, thereby pushing up the bottom end surface 51a of the float 51. As a result, the float 51 rises, so that the water leakage alarm color or colors of the trunk portion 53 become visible from outside, that is, the water leakage indicator 33 changes to the water leakage alarm state.

Since the water leakage indicator 33 shown in FIGS. 9 and 10 is configured to raise the float 51 using the expansion force of the water absorbent polymer member 54, it is possible to raise the float 51 by a longer distance than when raising the float 51 using the buoyancy of water. Thus, when the float 51 is raised by the water absorbent polymer member 54, the float 51 protrudes by a long distance from the water storage recess 50, so that the water leakage indicator 33 can reliably notify users of water leakage.

In the above embodiment, the water leakage indicators 33 include water leakage detecting floats. However, water leakage indicators 33 of a different type may be used. For example, water leakage indicators 33 may be used which is made from a material whose color changes when they get wet with water.

In the above embodiment, the water dispenser 1 is of the type in which drinking water is introduced into the temperature adjusting tank 15 from the replaceable raw water container 13. However, the present invention is also applicable to a water dispenser of the type in which drinking water is introduced into the temperature adjusting tank 15 from the public water supply through a water purifying filter.

### DESCRIPTION OF THE NUMERALS

1. Water dispenser
2. Self-propelled cleaning robot
3. Housing
4. Pedestal
5. Robot receiving space
5a. Opening
15, 18. Temperature adjusting tank
25. Cold water cock
28. Hot water cock
30. Seating surface portion
32. Groove portion
33. Water leakage indicator
35, 36. Support leg
43. Charging station
50. Water storage recess
51. Float
54. Water absorbent polymer member
60. Power cord
63. Power tap
F. Floor surface

1. A pedestal comprising:
a seating surface portion configured such that a water dispenser which is capable of dispensing drinking water in a temperature adjusting tank to outside through a cock is placed on the seating surface portion;
legs defining, under the seating surface portion, a robot receiving space which a self-propelled cleaning robot for cleaning a floor space can enter and exit, and in which the self-propelled cleaning robot can be received; and
a charging station provided in the robot receiving space and configured to charge the self-propelled cleaning robot.

2. The pedestal of claim 1, further comprising a groove portion around the seating surface portion so as to be recessed from, and located lower than, the seating surface portion,
wherein the groove portion is inclined such that water entering the groove portion collects to a front side where there is an opening through which the self-propelled cleaning robot can enter and exit the robot receiving space, and which is opposite from a rear side where there is the charging station, the rear side being opposite from the opening.

3. The pedestal of claim 2, further comprising a water leakage indicator at the front side and configured to be changed from a non-water-leakage-alarm state to a water leakage alarm state by water entering the groove portion.

4. The pedestal of claim 3, wherein the legs include right and left support legs located at the front side, and defining a width of the opening, and
wherein the water leakage indicator is provided utilizing an interior of one of the support legs.

5. The pedestal of claim 4, wherein the water leakage indicator comprises a water storage recess formed in the interior of the one of the support legs, and a float inserted in the water storage recess.

6. The pedestal of claim 1, wherein the legs comprise:
front right and front left support legs located at a front side where there is an opening through which the self-propelled cleaning robot can enter and exit the robot receiving space, and which is opposite from a rear side where there is the charging station, the rear side being opposite from the opening, the right and left support legs defining a width of the opening; and
a support leg located at the rear side,
wherein the charging station includes a transmitter configured to transmit, into the air, guiding electromagnetic waves for guiding the self-propelled cleaning robot to a charging position, and
wherein a space between the front right and front left support legs and the transmitter is open from the robot receiving space to an outer space.

7. The pedestal of claim 1, wherein the charging station includes a power tap which can be connected to a power cord of the water dispenser.

8. The pedestal of claim 6, further comprising a groove portion around the seating surface portion so as to be recessed from, and located lower than, the seating surface portion,
wherein the groove portion is inclined such that water entering the groove portion collects to a front side where there is an opening through which the self-propelled cleaning robot can enter and exit the robot receiving space, and which is opposite from a rear side where there is the charging station, the rear side being opposite from the opening.

9. The pedestal of claim 8, further comprising a water leakage indicator at the front side and configured to be changed from a non-water-leakage-alarm state to a water leakage alarm state by water entering the groove portion.

10. The pedestal of claim 9, wherein the legs include right and left support legs located at the front side, and defining a width of the opening, and
wherein the water leakage indicator is provided utilizing an interior of one of the support legs.

11. The pedestal of claim 10, wherein the water leakage indicator comprises a water storage recess formed in the interior of the one of the support legs, and a float inserted in the water storage recess.

12. The pedestal of claim 2, wherein the charging station includes a power tap which can be connected to a power cord of the water dispenser.

13. The pedestal of claim 3, wherein the charging station includes a power tap which can be connected to a power cord of the water dispenser.

14. The pedestal of claim 4, wherein the charging station includes a power tap which can be connected to a power cord of the water dispenser.

15. The pedestal of claim 5, wherein the charging station includes a power tap which can be connected to a power cord of the water dispenser.

16. The pedestal of claim 6, wherein the charging station includes a power tap which can be connected to a power cord of the water dispenser.

17. The pedestal of claim 8, wherein the charging station includes a power tap which can be connected to a power cord of the water dispenser.

18. The pedestal of claim 9, wherein the charging station includes a power tap which can be connected to a power cord of the water dispenser.

19. The pedestal of claim 10, wherein the charging station includes a power tap which can be connected to a power cord of the water dispenser.

20. The pedestal of claim 11, wherein the charging station includes a power tap which can be connected to a power cord of the water dispenser.
